(19) United States
(12) Patent Application Publication
(10) Pub. No.: US 2018/0193213 A1
(43) Pub. Date: Jul. 12, 2018

(54) POSITIONING DEVICE AND SYSTEM

(71) Applicant: EHOB, Inc., Indianapolis, IN (US)

(72) Inventors: James G. Spahn, Carmel, IN (US); Aaron D. Kadel, Indianapolis, IN (US); James Q. Bui, Carmel, IN (US); Tyler K. Oehlman, Indianapolis, IN (US); Gregory R. Konkle, Indianapolis, IN (US)

(21) Appl. No.: 15/870,845

(22) Filed: Jan. 12, 2018

Related U.S. Application Data
(60) Provisional application No. 62/445,612, filed on Jan. 12, 2017.

(51) Int. Cl. A61G 7/10; B32B 7/02; B32B 3/04; B32B 3/08; B32B 5/06; B32B 7/14

(52) U.S. Cl. CPC A61G 7/1023; B32B 7/02; B32B 3/04; B32B 3/08; B32B 5/06; B32B 2535/00; B32B 2262/0276; B32B 2307/724; B32B 2307/746; B32B 2307/726; B32B 7/14

(57) ABSTRACT

A positioning device including a glide sheet including handles that are located inwardly of glide sheet peripheral edges, whereby patient extremity entanglements with the handles are avoided and SPH practices are promoted. According to one embodiment the handles are integrally formed into the bottom side surface of the glide sheet. According to another embodiment, the handles are located between the top side surface and the bottom side surface of the glide sheet. Also, a positioning system including such a positioning device used with one or more removable, elongate handle assemblies, and/or a replaceable, moisture-absorbent pad, with such a pad optionally including first and second longitudinally extending adhesive strips that are laterally spaced to locations in proximity to the laterally opposite edges of the pad.

### CROSS-REFERENCE TO RELATED APPLICATIONS

This application claims the benefit, under Title 35, U.S.C. § 119(e), of U.S. Provisional Patent Application Ser. No. 62/445,612 entitled POSITIONING DEVICE AND SYSTEM, filed Jan. 12, 2017, the entire disclosure of which is incorporated herein by reference.

### BACKGROUND

1. Field of the Invention

The present invention relates to devices facilitating the turning or repositioning of bedridden patients by caregivers. Herein, such devices may be generally referred to as “positioning devices”.

2. Description of the Related Art

Safe Patient Handling (“SPH”) relates to the occupational health and safety of caregivers with respect to the handling of patients, which includes the turning, repositioning, transference, or otherwise moving or supporting patients bodily. Objectives of SPH include preventing injuries to caregivers due, for example, to muscle strain, and facilitating greater ease in handling their patients.

Without periodic turning or other repositioning relative to a support surface, a bedridden patient can develop pressure ulcers. Therefore, periodic turning of a patient is routinely performed by caregivers to prevent the occurrence or lessen the severity of pressure ulcers in the patent. Typically, patient turning is performed every two hours according to a q2 protocol, a turning regimen well-known in the relevant art.

Accordingly, a patient may, for example, be moved from a first orientation flat on his back, wherein his body superposes a first support surface (such as a mattress surface) substantially orthogonally, to a second orientation in which his body superposes the mattress surface substantially obliquely. In the second orientation, the patient's body may be supported at a rightwardly oblique angle relative to the mattress by one or more second support surfaces. Commonly, the second support surfaces are defined by a pair of foam wedge members spaced longitudinally (i.e., along the length of the bed) and interposed between the patient and the mattress. The patient may then be turned after two hours from the second orientation to a third orientation in which his body is supported at a leftwardly oblique angle relative to the mattress by one or more third support surfaces, which may comprise the selfsame pair of foam wedges relocated to the patient's opposite lateral side. Two hours later the patient may be returned to the first orientation.

Additionally, moving a patient, even for the purposes of carrying out the turning regimen, can induce shear stresses in the patient's skin or body tissues and have deleterious effects, particularly where the patient is susceptible to friction-induced tissue damage.

Hence, patient movement is necessary to prevent pressure ulcer development or exacerbation, but is also beneficial to the patient when done with minimal shear stressing of his skin or body tissues. Moreover, patient movement is beneficial to the caregiver(s) when performed according to SPH practices.

Therefore, positioning devices are commonly used to facilitate SPH of bedridden patients, preferably while minimizing shear stresses imparted to their bodies.

Types of positioning devices relevant to this disclosure include devices comprising a glide sheet having an upper or top side surface superposed by the patient, and an opposite, lower or bottom side surface that superposes a support surface, such as a bed mattress, support wedge(s), and/or mattress-covering sheet. The bottom side surfaces of prior glide sheets are typically slick, and have coefficients of friction lower than that of the top side surface or the support surface. The slick bottom side surface facilitates sliding movement of the glide sheet and the patient, relative to the support surface(s), by the caregiver(s) pulling the glide sheet.

In some prior positioning devices, the glide sheet top side material layer is typically polyester, and the bottom side material layer is typically polyester or rip-stop nylon, both of which are moisture permeable and breathable fabrics. The polyester top side material layer also provides some moisture wicking properties. Such prior positioning devices ordinarily facilitate convective airflow and heat transfer therethrough, particularly when the patient is obliquely positioned and supported by wedges as described above, which creates between the patient and the mattress an air space receivable of heat, air and/or moisture from the glide sheet.

In certain prior positioning devices, the patient directly interfaces the top side surface of the glide sheet. Such positioning devices are wholly disposable, and intended to be replaced when soiled or wetted, as by perspiration or incontinence; some of these positioning devices are additionally provided with a moisture-absorbing pad disposed between the patient and the top side surface that wicks and retains perspiration and/or urine.

Certain other prior positioning devices provide replaceable moisture-absorbent pads removably secured to the top side surface of the glide sheet; the glide sheets of such devices may thus be used indefinitely, whereas the pads are disposable. Such pads may cover a substantial portion of the rectangular top side surface area. These rectangular pads may be provided with large adhesive patches at their corners to satisfactorily retain their affixed positions on the glide sheet top side surface. Adhesives useful for such applications tend to be air impermeable, and where localized, as at the corners of the disposable pad, tend to be rather large and can consequently compromise air flow through the positioning device, and heat transmission away from the patient. Moreover, pads are typically sized to cover a substantial portion of the glide sheet top side surface, and can therefore have considerable length. The placement of adhesive patches at remote corners of the pad leaves the longitudinally centermost portion of the pad unsecured to the glide sheet. Consequently, undesirable pad bunching or other displacement of the pad relative to the glide sheet can result.

Alternatively, in some prior positioning devices the glide sheet top side surface is treated with a surface coating that increases its coefficient of friction, whereby the disposable pad is secured in place by friction. However, the increased coefficient of friction the coating provides undesirably reduces the top side material layer's breathability and moisture wicking and permeability capabilities.

Thus, prior positioning devices variably include glide sheets that are themselves intended for disposal after a period of use, or that may be maintained in service indefinitely by changing replaceable moisture-absorbing pads as needed. In either type, improvements in positioning device breathability, moisture wicking and heat transmission capabilities, and disposable pad retention, are generally desirable.

As mentioned above, positioning devices and the patient are moved relative to the support surface(s) by pulling the glide sheet. Prior positioning devices are provided with a plurality of handles each permanently affixed to either the top or bottom side surface near the glide sheet lateral edges. Each handle of a prior positioning device typically defines a loop or other handhold portion by which any caregiver grasps the handle at a single, fixed location, regardless of differing caregiver heights, strengths, and reaches, or position or location from which the caregiver must pull. Consequently, some caregivers may experience greater strain than others when utilizing prior positioning devices to move patients. Positioning device handles that facilitate SPH while better accommodating a wide variety of caregiver sizes, strengths, reaches, or pulling positions or locations, are desirable.

Moreover, sometimes patient extremities (e.g., hands, arms, legs, or feet) become entangled in the loops or handholds defined by the permanently affixed handles of prior positioning devices. Such entanglements can be dangerous, and result in blood flow restrictions, bruising, fractures, falls, impaired call button access, or other problems. Positioning device handles that prevent such entanglements are desirable.

### SUMMARY

The invention comprises, in one form thereof, a positioning device or positioning system including a glide sheet having integrally formed handles located in the bottom side surface, whereby patient entanglement with the handles is avoided. The handles promote SPH practices.

Some embodiments of the invention provide a positioning device for facilitating the turning or repositioning of a bedridden patient by one or more caregivers, the positioning device including a glide sheet having a top side surface superposeable by the patient and an opposite, bottom side surface adapted to superpose a support surface, the top side surface and the bottom side surface each bounded by peripheral edges of the glide sheet, the glide sheet having a perimeter defined by the peripheral edges. The glide sheet includes a plurality of handles located inwardly of the glide sheet peripheral edges. The plurality of handles is integrally formed into the bottom side surface of the glide sheet, whereby patient extremity and handle entanglement is avoided and SPH practices are promoted.

The invention comprises, in another form thereof, a positioning device or positioning system including a glide sheet having handles located between the top side surface and the bottom side surface and inwardly of the glide sheet edges, whereby patient entanglement with the handles is avoided. The handles promote SPH practices, and may be grasped by the caregiver with either an overhand or underhand grip.

Some embodiments of the invention provide a positioning device for facilitating the turning or repositioning of a bedridden patient by one or more caregivers, the positioning device including a glide sheet having a top side surface superposeable by the patient during use and an opposite, bottom side surface adapted to superpose a support surface during use, the top side surface and the bottom side surface each bounded by peripheral edges of the glide sheet. The glide sheet includes a plurality of handles located inwardly of the glide sheet peripheral edges. The plurality of handles is located between the top side surface and the bottom side surface of the glide sheet, whereby patient extremity and handle entanglement is avoided and SPH practices are promoted.

The invention comprises, in another form thereof, a replaceable, moisture-absorbent pad for optional use with a positioning device or positioning system including a glide sheet.

Some embodiments of the invention provide a positioning system including a positioning device as described above, and a replaceable, moisture-absorbent pad for optional use with the glide sheet, the pad adherently positionable on the top side surface of the glide sheet during use.

In some embodiments of such a system, the pad has longitudinally opposite ends and laterally opposite edges, and includes a pair of parallel, longitudinally-extending, adhesive strips that extend substantially the entire longitudinal length of the pad. Each of the adhesive strips is located in proximity to a respective one of the laterally opposite edges of the pad, and the pad is retained to the top side surface of the glide sheet by the adhesive strips along the entire length of the pad, whereby bunching of the longitudinally centermost portion of the pad and other undesirable displacement of the pad relative to the glide sheet is prevented.

The invention comprises, in another form thereof, a positioning device or positioning system receivable of removable handles, whereby patient entanglement with the handles is avoided while unattended, and SPH practices by caregivers of various heights and reaches are promoted.

Some embodiments of the invention provide a positioning system including a positioning device as described above, and a removeable, elongate handle assembly, the handle assembly comprising an elongate strap portion defined by a fabric ribbon, the ribbon folded over itself longitudinally to define a handle assembly first end and an opposing handle assembly second end. The elongate strap portion is affixed to itself at loci between the handle assembly first end and the handle assembly second end to define a plurality of loops, the plurality of loops distributed along the length of the handle assembly with a first loop of the plurality of loops located at the handle assembly first end and a second loop of the plurality of loops located at the handle assembly second end. The handle assembly second end is selectively engageable with the glide sheet, and then receivable through the first loop, with the second loop and at least a portion of a third loop of the plurality of loops disposed between the handle assembly second end and the first loop and are receivable of at least the fingers of a caregiver hand, whereby the second and third loops define a plurality of handles located at different distances from the glide sheet for use by the caregiver(s) for moving the glide sheet during patient repositioning, whereby SPH practices by caregivers of various heights and reaches are promoted. The handle assembly is removable subsequent to use by the caregiver(s), from the glide sheet pocket, whereby patient extremity and handle assembly entanglement is avoided while the patient is unattended.

### BRIEF DESCRIPTION OF THE DRAWINGS

The various objects, features and attendant advantages of the present invention will become fully appreciated as the same becomes better understood when considered in conjunction with the accompanying drawings. Although the drawings represent embodiments of the disclosed apparatus, the drawings are not necessarily to scale or to the same scale and certain features may be exaggerated or omitted in order to better illustrate and explain the present disclosure. Moreover, in accompanying drawings that show sectional views, cross-hatching of various sectional elements may have been omitted for clarity. It is to be understood that this omission of cross-hatching is for the purpose of clarity in illustration only.

FIG. 1 is a top perspective view of a first embodiment of a positioning device according to the present disclosure;

FIG. 2 is a bottom perspective view of the positioning device embodiment of FIG. 1;

FIG. 3 is an enlarged, partial view of the positioning device shown in FIG. 2;

FIG. 4 is a top perspective view of a second embodiment of a positioning device according to the present disclosure;

FIG. 5 is a bottom perspective view of the positioning device embodiment of FIG. 4;

FIG. 6 is an enlarged, partial view of the positioning device shown in FIG. 5;

FIG. 7 is a fragmented cross-sectional longitudinal view along line 7-7 of FIG. 6;

FIG. 8 is a fragmented cross-sectional longitudinal view along line 8-8 of FIG. 6;

FIG. 9 is a side view of the positioning device of FIG. 7 in the direction of arrow 9;

FIG. 10 is a view of an embodiment of a removable handle assembly for use with a positioning device according to the present disclosure, and a sectioned, partial view of the positioning device of FIGS. 1 to 3;

FIG. 11 is a view of the removable handle assembly operably connected to the positioning device shown in FIG. 10;

FIG. 12 is a view of an embodiment of a removable handle assembly for use with a positioning device according to the present disclosure, and a sectioned, partial view of the positioning device of FIGS. 4 to 9;

FIG. 13 is a view of the removable handle assembly operably connected to the positioning device shown in FIG. 12;

FIG. 14 is a top plan view of an embodiment of an absorbent pad according to the present disclosure; and

FIG. 15 is a bottom plan view of the absorbent pad shown in FIG. 14.

Corresponding reference characters indicate corresponding parts throughout the several views. The exemplary embodiments set forth herein are not to be construed as limiting the scope of the invention in any manner.

### DETAILED DESCRIPTION OF EMBODIMENT(S)

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Exemplary apparatus and system embodiments according to the present disclosure are discussed below in detail with reference to the accompanying drawings. In the following detailed description, numerous specific details are set forth in order to provide a thorough understanding of the present invention. It will, however, be obvious to those of ordinary skill in the relevant art that the present invention may be practiced without these specific details. In other instances, well-known structures are not shown in detail in order to avoid unnecessary obscuring of the present invention.

Furthermore, there is no intention to be bound by any expressed or implied theory presented in the preceding technical field, background, brief summary or the following detailed description. It is also to be understood that the specific embodiments illustrated in the attached drawings and described herein are simply exemplary embodiments of the inventive concepts defined by the appended claims. Hence, specific dimensions and other physical characteristics relating to the embodiments disclosed herein are not to be considered as limiting, except as claimed.

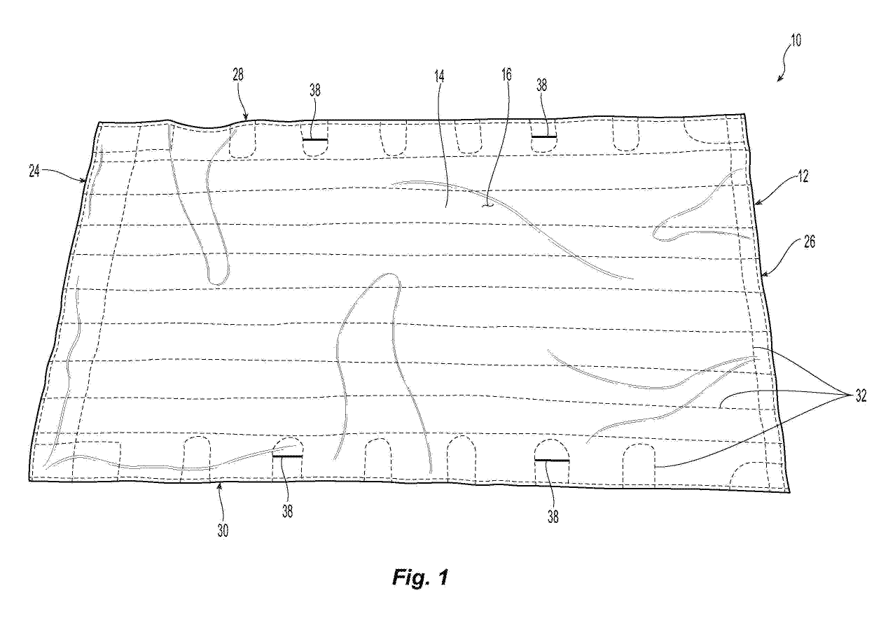

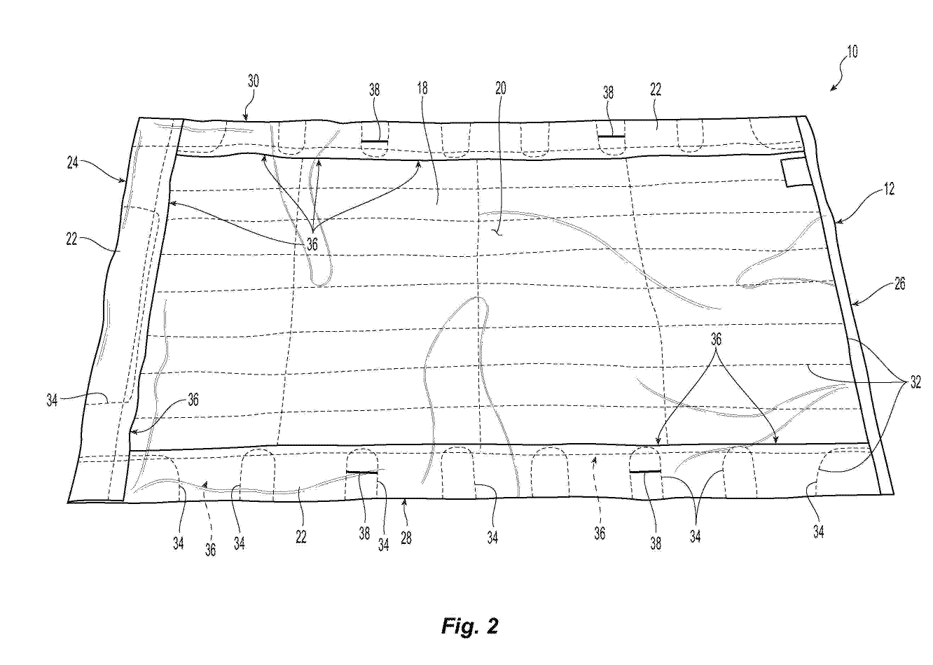

FIGS. 1 and 2 show opposing top and bottom sides of a first exemplary embodiment of a positioning device according to the present disclosure. Positioning device 10 includes rectangular glide sheet 12 formed of top material layer 14 defining glide sheet top side surface 16 shown in FIG. 1, and bottom material layer 18 defining glide sheet bottom side surface 20. In use, the patient superposes glide sheet top side surface 16, and glide sheet bottom side surface 20 superposes the support surface (not shown) such as a bed mattress, with the glide sheet length extending in the bed's longitudinal direction, which extends between the head and foot of the bed. Depicted glide sheet 12 is of a standard positioning device size, and has an overall length in a longitudinal direction of approximately 57 inches, and an overall width in a lateral direction, which is substantially perpendicular to the longitudinal direction, of approximately 34 inches, although it is envisioned that the length and width dimensions of this and other glide sheet embodiments herein described may be longer or shorter. In particular, it may be desirable to utilize a longer glide sheet to assure its extension beneath the patient's head as well as his body and at least a portion of his legs, whereby the patient's head is carried by positioning device 10 and moved with his body during repositioning.

Top material layer 14 superposes and is affixed to bottom material layer 18. The materials of layers 14 and 18 may be substantially as used in some prior positioning devices. For example, top material layer 14 may be brushed polyester fabric, and bottom material layer 18 may be a rip-stop nylon or polyester fabric. Top material layer 14 is moisture and air permeable, provides a degree of moisture absorbency, and has wicking capabilities to help distribute moisture over a large portion the glide sheet surface area. Bottom material layer 18 is slick and has a relatively low coefficient of friction which facilitates sliding movement of the patient and glide sheet along the support surface(s), and is also air and moisture permeable. Air, moisture and heat are transmissible through the overall thickness of glide sheet 12.

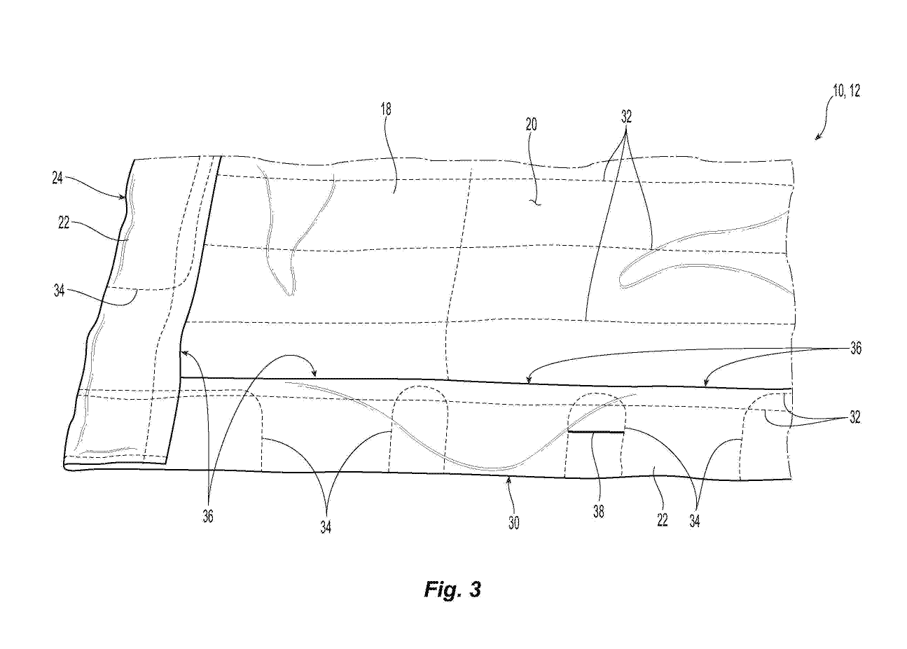

Referring to FIGS. 2 and 3, bottom side surface 20 includes an inwardly folded, hemmed portion of bottom material layer 18 that overlies edges of glide sheet 12 to form edging portion or border 22. In the depicted embodiment, border 22 extends longitudinally between glide sheet first end edge 24 and glide sheet second end edge 26 along glide sheet first lateral edge 28 and glide sheet second lateral edge 30, and laterally between glide sheet first lateral edge 28 and glide sheet second lateral edge 30 along glide sheet first end edge 24. In the depicted embodiment, border 22 does not extend along glide sheet second end edge 26, although in some other embodiments it may.

Top material layer 14 and bottom material layer 18 are hemmed to define substantially equivalent overall dimensions, and establish boundaries that are aligned to define glide sheet edges 24, 26, 28 and 30 and substantially equivalently sized top and bottom side surfaces 16 and 20. Top and bottom material layers 14 and 18 are hemmed and secured to each other by glide sheet stitching 32, which also secures border 22 in place upon bottom side surface 20. Stitching 32 includes arcuate portions 34 which respectively extend continually between spaced locations along one, or between adjacent ones, of glide sheet edges 24, 28 and 30, as best seen in FIG. 2. Stitching arcuate portions 34 extend continuously from or to their respective edge(s) 24, 28 and 30, and generally toward or away from the center of the glide sheet 12. Stitching arcuate portions 34 are confined within border 22, and near the inward edges of border 22 smoothly change direction, whereby the closed, arch-shaped areas are circumscribed by stitching arcuate portions 34 along an edge 24, 28 or 30. Along the perimeter of glide sheet 12, border 22 and the overlaid portion of bottom material layer 18 define pocket 36 between each pair of adjacent stitching arcuate portions 34. The width of border 22 defines the depth of each pocket 36, and the distance between the adjacent stitching arcuate portions 34 defines the width of each pocket 36. Each pocket 36 is approximately four (4) inches square, and defines an integrally formed glide sheet handle for use by the caregiver(s), into which some or all of a caregiver's fingers are receivable for pulling glide sheet 12 during patient repositioning.

Integral pockets or handles 36 obviate the permanently affixed handles of prior positioning devices which, as described above, can present potential patient extremity and handle entanglement issues. Moreover, the opening location of each pocket or handle 36 being on the bottom side surface 20 and inwardly of the glide sheet perimeter, minimizes the likelihood being encountered by the hand or foot of a patient. Additionally, the location and orientation of the openings of pockets or handles 36 cause a caregiver to grasp it palm-up, whereby pulling in a lateral direction is done with a bicep curl-like motion.

Along each glide sheet lateral edge 28 and 30, two of the arch-shaped areas defined by stitching arcuate portions 34 are provided with longitudinally-extending, reinforced slits or buttonholes 38, as best seen in FIG. 2. As discussed further below, buttonholes 38 are receivable of removable handle assemblies that better allow the caregiver(s) to pull the glide sheet in accordance with SPH practices.

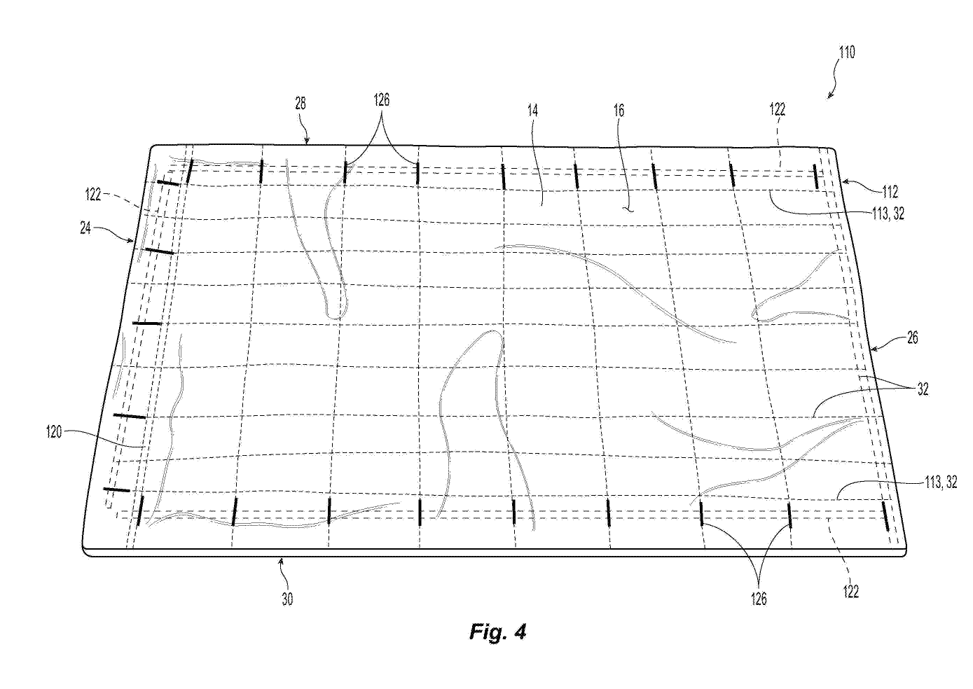

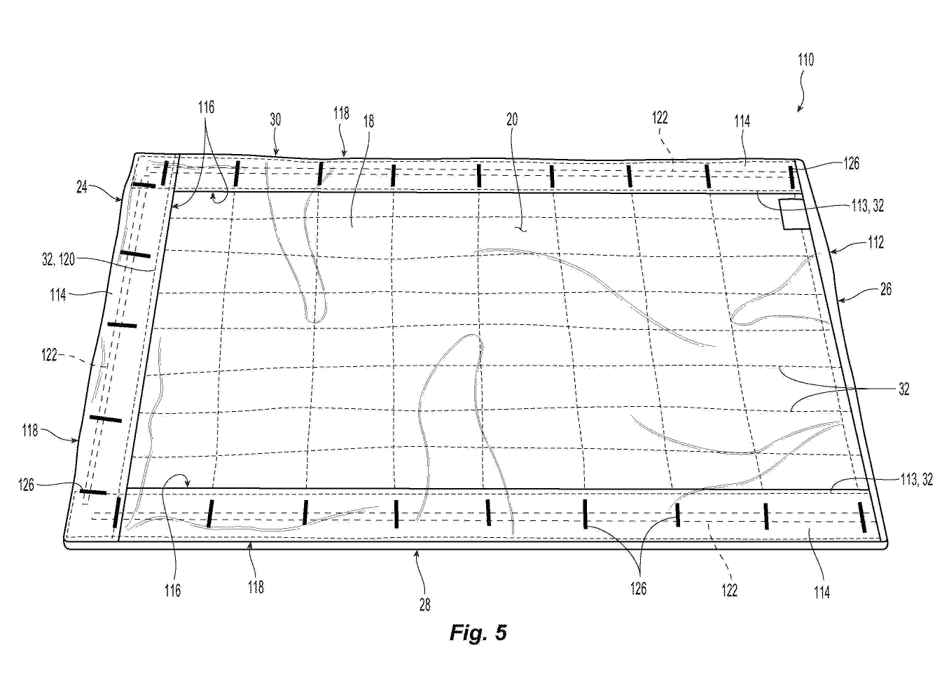

FIGS. 4 and 5 show opposing top and bottom sides of a second exemplary embodiment of a positioning device according to the present disclosure. Second embodiment positioning device 110 is structurally and functionally similar to first embodiment positioning device 10, and similar or corresponding elements are commonly referenced numerically. Positioning device 110 includes rectangular glide sheet 112 which, like glide sheet 12, is formed of top material layer 14 defining glide sheet top side surface 16 shown in FIG. 4, and bottom material layer 18 defining glide sheet bottom side surface 20. As with positioning device 10, in use, the patient superposes glide sheet top side surface 16, and glide sheet bottom side surface 20 superposes the support surface (not shown) such as a bed mattress, with the glide sheet length extending in the bed's longitudinal direction, which extends between the head and foot of the bed. Like depicted first embodiment glide sheet 12, depicted second embodiment glide sheet 112 is also of a standard positioning device size, and has an overall length in a longitudinal direction of approximately 57 inches, and an overall width in a lateral direction, which is substantially perpendicular to the longitudinal direction, of approximately 34 inches. It is envisioned that the length and width dimensions of this and other glide sheet embodiments herein described may likewise be longer or shorter, and may extend beneath the patient's head as well as his body and at least a portion of his legs, whereby positioning device 110 may carry the patient's head for movement with his body during repositioning.

In glide sheet 112, top material layer 14 superposes and is affixed to bottom material layer 18, as in glide sheet 12. As described above, the top and bottom material layers may comprise brushed polyester fabric and rip-stop nylon or polyester fabric, respectively, whereby top material layer 14 is moisture and air permeable, provides a degree of moisture absorbency, and has wicking capabilities to help distribute moisture over a large portion the glide sheet surface area, and bottom material layer 18 is slick and has a relatively low coefficient of friction which facilitates sliding movement of the patient and glide sheet along the support surface(s), and is also air and moisture permeable. Air, moisture and heat are transmissible through the overall thickness of glide sheet 112.

In second embodiment glide sheet 112, top material layer 14 and bottom material layer 18 are hemmed to define substantially equivalent overall dimensions, and establish boundaries that are aligned to define glide sheet edges 24, 26, 28 and 30 and substantially equivalently sized top and bottom side surfaces 16 and 20, as with first embodiment glide sheet 12. Top and bottom material layers 14 and 18 are hemmed and secured to each other by glide sheet stitching 113.

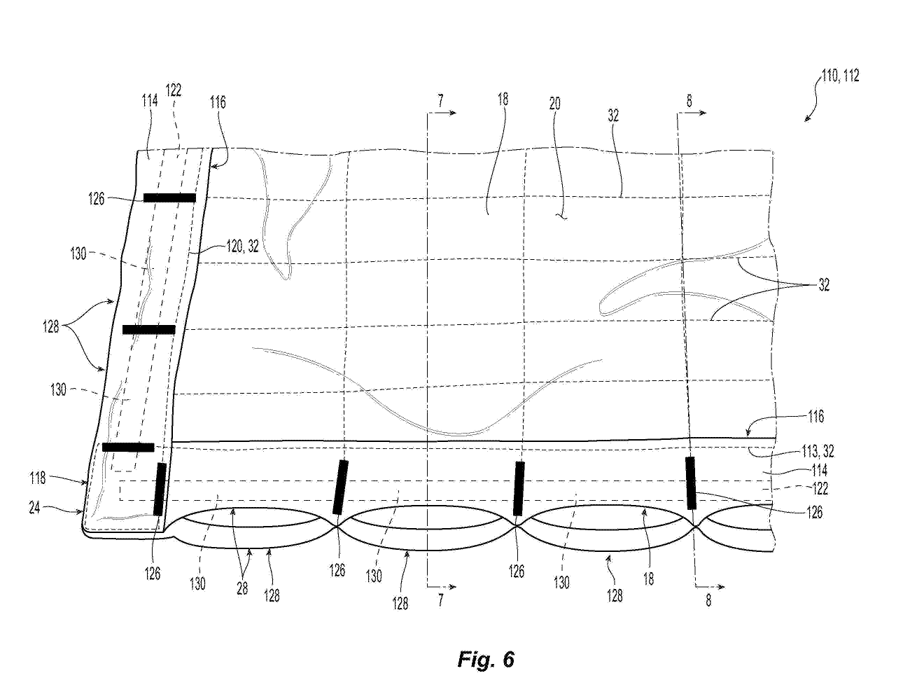

Referring to FIGS. 5 and 6, bottom side surface 20 of glide sheet 112 includes separately attached, hemmed, elongate strips of the same type of material comprising bottom material layer 18, the strips overlying the periphery of glide sheet 112 to form edging portion or border 114. Border 114 has an inward edge 116 and an outward edge 118 between which is a distance of about five (5) to six (6) inches. Border 114 extends longitudinally between glide sheet first end edge 24 and glide sheet second end edge 26 along glide sheet first lateral edge 28 and glide sheet second lateral edge 30, and laterally between glide sheet first lateral edge 28 and glide sheet second lateral edge 30 along glide sheet first end edge 24. In the depicted embodiment, border 114 does not extend along glide sheet second end edge 26, although in some other embodiments it may. Border outward edge 118 is aligned with glide sheet edges 24, 28, 30. Border inward edge 116 is secured to top and bottom material layers 14, 18 by longitudinal glide sheet stitching 113, and by laterally-extending stitching 120. The bottom-facing surface of border 114 thus defines a portion of glide sheet bottom side surface 20.

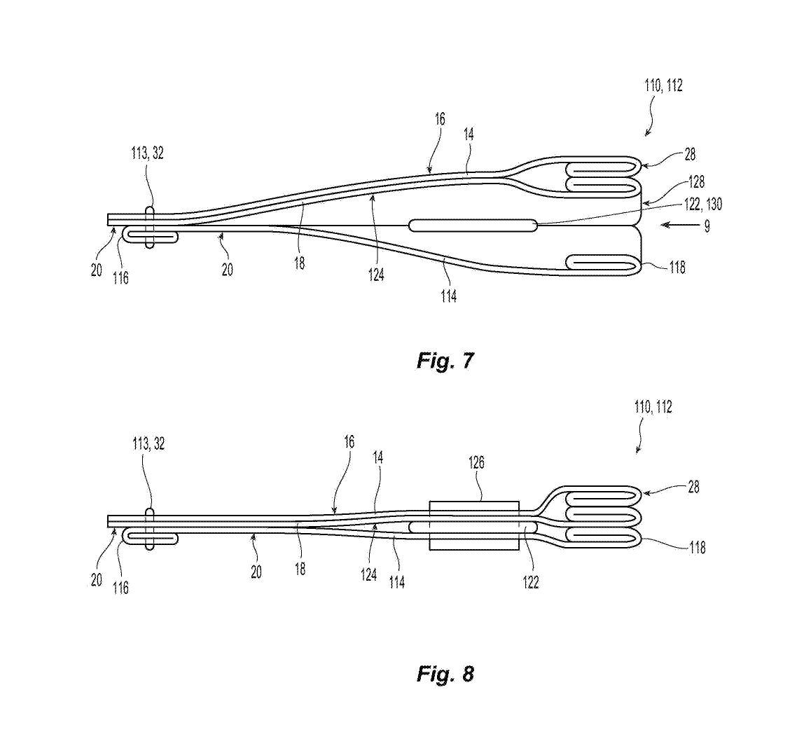

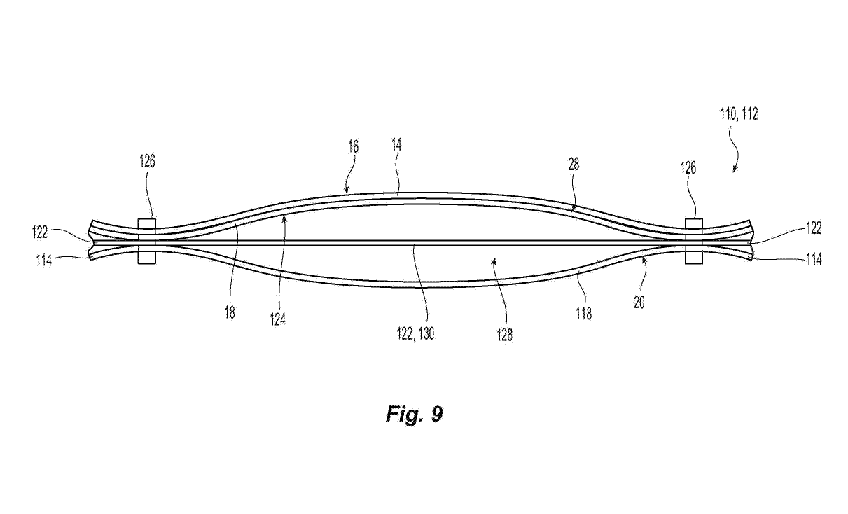

Second embodiment positioning device 110 includes elongate ribbons 122 made of nylon webbing material, each approximately one (1) inch wide, that extend substantially the entire lengths of glide sheet edges 24, 28, 30. Each ribbon 122 is positioned between and spaced from border inward and outward edges 116, 118, and is disposed between border 114 and bottom-facing surface 124 overlaid by border 114. Bartack stitches 126 extending in directions perpendicular to glide sheet edges 24, 28, 30 are provided along those edges at intervals of about six (6) to seven (7) inches. Bartack stitches 126 project through border 114, ribbon 122, bottom material layer 18 and top material layer 14, i.e., between the portion of bottom side surface 20 defined by border 114 and top side surface 16. Pockets 128 are thus provided between each adjacent pair of bartack stitches 126 along each respective glide sheet edge 24, 28, 30, each pocket 128 having an opening located at the respective edge 24, 28, 30, as best seen FIGS. 6 to 9. The portion of ribbon 122 enclosed within each respective pocket 128 defines a glide sheet handle 130 for use by the caregiver(s) to pull glide sheet 112 during patient repositioning.

As handles 130 are accessible only by opening and reaching into the respective pockets 128 from their openings in edges 24, 28, 30 of glide sheet 112, potential patient extremity and handle entanglement issues are avoided. Additionally, handles 130 may be grasped by a caregiver with either a palm-up or palm-down grip, affording greater flexibility while still promoting SPH practices.

Positioning device 10 or 110 may be used with one or more removable, elongate handle assemblies 40. Handle assembly 40 allows the caregiver(s) to more easily reach a handle by which glide sheet 12 or 112 can be pulled during patient repositioning, and is quickly and easily installed or removed, thereby avoiding the possibility of the patient becoming entangled with it while unattended. Together with positioning device 10 or 110, one or more handle assemblies 40 can define an embodiment of a positioning system according to the present invention.

Handle assembly 40 includes elongate strap portion 42 defined by a ribbon of, for example, nylon webbing having a width approximating the length of each buttonhole 38 of glide sheet 12. Strap portion 42 is folded over itself longitudinally to define handle assembly first end 44 and opposing handle assembly second end 46. A rectangular patch of nylon material having longitudinally opposite hemmed edges defines handle assembly abutment portion 48. The width of abutment portion is substantially (e.g., three times) greater than the width of the ribbon nylon webbing of handle 40; consequently, abutment portion 48 cannot pass through buttonhole 38 when used with glide sheet 12, as described further below. Abutment portion 48 extends longitudinally between its hemmed ends, which define generally rigid abutment portion first end 50 located proximate strap assembly first end 44, and generally rigid abutment portion second end 52. Abutment portion 48 is laterally centered relative to strap portion 42 and affixed thereto. Strap portion 42 defines loop 54 at handle assembly first end 44, adjacent to abutment portion first end 50. Loop 54 is of sized to accommodate insertion of strap assembly second end 46 and passage of the doubled strap portion 42 therethrough.

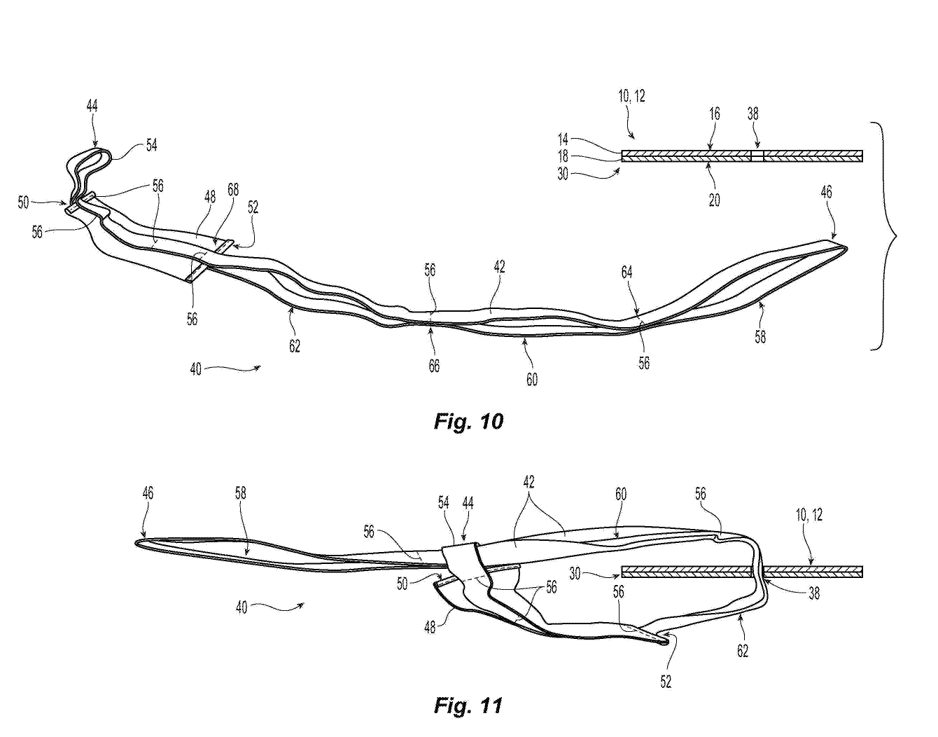

Referring to FIGS. 10 and 11, to use handle assembly 40 with first embodiment positioning device 10, second end 46 of handle assembly 40 is inserted through button hole 38 from bottom side surface 20 of glide sheet 12, and strap portion 42 is drawn through buttonhole 38 until second end 52 of abutment portion 48 abuts bottom side surface 20. Handle assembly second end 46 is then inserted through loop 54 and strap portion 42 is pulled through loop 54, making a substantial portion of the strap portion length between handle assembly second end 46 and abutment portion second end 52 available to the caregiver for pulling glide sheet 12.

Stitching 56 secures strap portion 42 to abutment portion 48, and to itself, as best seen in FIG. 10. Longitudinally spaced loci of stitching 56 between the doubled layers of strap portion 42 define a plurality of longitudinally spaced loop handles: Handle assembly 40 of the depicted embodiment provides discrete, longitudinally spaced first handle 58, second handle 60 and third handle 62, each of substantially equivalent size and sufficient for insertion of a caregiver's entire hand, whereby a secure grip on the strap portion may be obtained for pulling. First handle 58 is defined between handle assembly second end 46 and stitching locus 64; second handle is defined between stitching loci 64 and 66; and third handle 62 is defined between stitching loci 66 and 68.

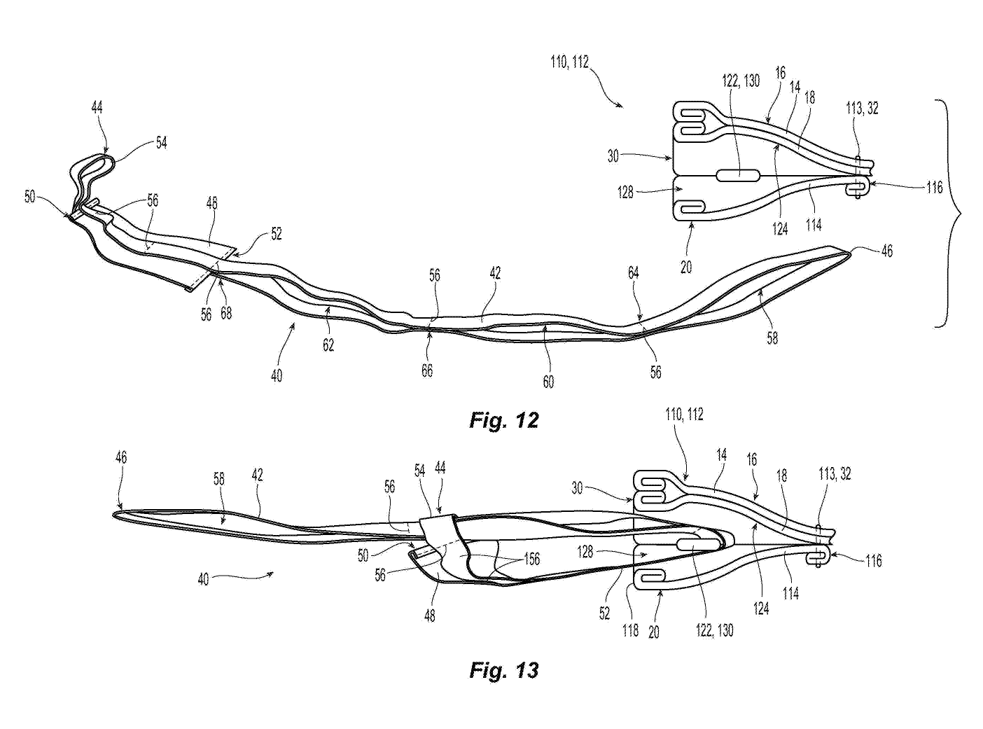

Referring now to FIGS. 12 and 13, above-described handle assemblies 40 may similarly be used with second embodiment positioning device 110 to allow the caregiver(s) to more easily reach a handle by which glide sheet 112 can be pulled during patient repositioning, and is quickly and easily installed or removed, thereby avoiding the possibility of the patient becoming entangled with it while unattended.

To use handle 40 with positioning device 110, second end 46 of handle assembly 40 is inserted into pocket 128, wrapped about handle 130 therein, and pulled out of pocket 128. Handle assembly second end 46 is then inserted through loop 54 and strap portion 42 is pulled through loop 54, making a substantial portion of the strap portion length between handle assembly second end 46 and abutment portion second end 52 available to the caregiver for pulling glide sheet 112.

By providing discrete, longitudinally spaced handles 58, 60 and 62, removable handle assembly 40 allows a caregiver positioned too far from a glide sheet handle easily reach a glide sheet handle (e.g., handle 36 or 130), to safely exert a pulling motion on the glide sheet through separable handle assembly 40 for repositioning the patient. The provision of multiple handles 58, 60, 62 at differing distances from a glide sheet (e.g., glide sheet 12 or 112) allows a caregiver utilizing handle assembly 40 to select a handle that accommodates SPH practices and offers the best mechanical advantage.

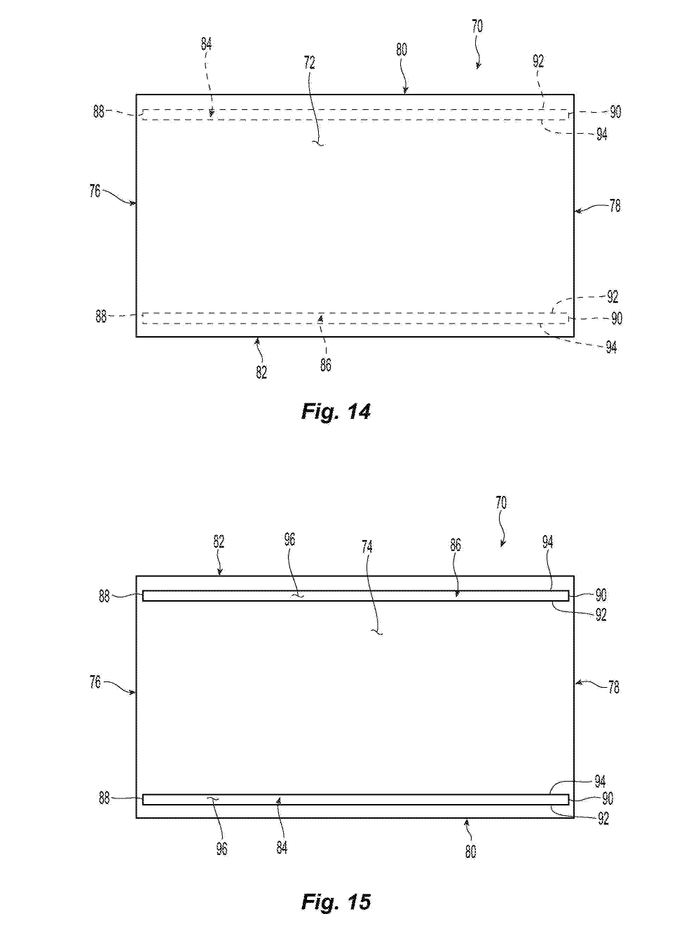

Positioning device 10 or 110 optionally includes a prior replaceable, moisture-absorbent pad positioned on its glide sheet top side surface 16. Alternatively, positioning device 10 or 110 may optionally include replaceable, moisture-absorbent pad 70 shown in FIGS. 14 and 15. Together with a replaceable, moisture-absorbent pad according to the prior art, or a pad 70 according to the present invention, positioning device 10 or 110 can define a positioning system.

It is to be also understood, however, that pad 70 itself as herein described may be used with various positioning devices according to the prior art that, like positioning device 10 or 110, comprise a glide sheet capable of use with replaceable, moisture-absorbent pads upon their respective top side surfaces. Hence, replaceable, moisture-absorbent pad 70 itself, apart from its use with any particular positioning device, may be construed as inventive, although it is herein described in the context of its optional use with positioning device 10 or 110.

Pad 70 is substantially rectangular and has top side surface 72 and opposing bottom side surface 74 that are both bounded by first end edge 76 and longitudinally opposite second end edge 78, and first lateral edge 80 and laterally opposite second lateral edge 82.

Pad 70 is similar to prior pads with regard to its size relative to the area of glide sheet top side surface 16 of positioning device 10 or 110. Pad 70 is substantially moisture and air impermeable, and its structure and materials provide moisture wicking, distribution and absorbency capabilities comparable to known prior, currently commercialized pads, and facilitates radiant and conductive heat transmission therethrough. For example, pad 70 may, like prior disposable pads, comprise a bottom layer of polyurethane material that interfaces glide sheet top side surface 16, and an absorbent top layer comprising a polyester/rayon mixture that interfaces the patient. Glide sheet 12 or 112 of respective positioning device 10 or 110 may be reused indefinitely with replacements of pad 70 as needed.

Bottom side surface 74 is provided with laterally spaced, longitudinally extending first adhesive strip 84 and second adhesive strip 86. Adhesive strips 84 and 86 each respectively extend between first longitudinal end 88 and second longitudinal end 90 thereof. Longitudinal ends 88 and 90 are respectively proximate to pad end edges 76 and 78. In other words, adhesive strips 84 and 86 extend substantially the entire length of pad 70. Moreover, adhesive strips 84 and 86 are substantially parallel and laterally spaced to locations in proximity with (e.g., within approximately one (1) to two (2) inches) of pad lateral edges 80 and 82, respectively. Each adhesive strip 84, 86 is provided with a selectively exposed adhesive surface 96 that releasably adheres to top side surface 16, 116 of glide sheet 12, 112. Adhesive surface 96 is defined by commercially available adhesive commonly used for retaining similar prior absorbent pads to prior glide sheets, and may be selectively exposed by peeling away an elongate, separable covering film (not shown) of known type. Each adhesive strip 84, 86 is preferably one and one-half (1.5) to two (2) inches wide between its respective first lateral edge 92 and second lateral edge 94; it has been found that adhesive strips narrower than this width range are insufficiently retained to the glide sheet top side surface, and that adhesive strips wider than this width range are undesirably retained too securely to the glide sheet top side surface. Pad 70, by virtue of its laterally spaced adhesive strips 84 and 86 ensures that the centermost portion of the pad remains secured to glide sheet 12 or 112, and helps prevent undesirable pad bunching or other displacement of pad 70 relative to the glide sheet.

While described herein with respect to particular embodiments, the present invention(s) can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A positioning device for facilitating the turning or repositioning of a bedridden patient by one or more caregivers, the positioning device comprising:
a glide sheet having a top side surface superposeable by the patient and an opposite, bottom side surface adapted to superpose a support surface, the top side surface and the bottom side surface each bounded by peripheral edges of the glide sheet, the glide sheet having a perimeter defined by the peripheral edges;
wherein the glide sheet includes a plurality of handles located inwardly of the glide sheet peripheral edges; and
wherein the plurality of handles is integrally formed into the bottom side surface of the glide sheet, whereby patient extremity and handle entanglement is avoided and SPH practices are promoted.

2. The positioning device of claim 1, wherein the top side surface is defined by a top material layer and the bottom side surface is defined by a bottom material layer, the bottom material layer has a coefficient of friction that is less than the coefficient of friction of the top material layer, and the top material layer superposes and is affixed to the bottom material layer;
wherein the bottom side surface includes hemmed portion of the bottom material layer that is folded inwardly into overlying relationship with the bottom material layer, to form a border along at least two glide sheet peripheral edges; and
wherein, along the perimeter of the glide sheet, the border and the portion of the bottom material layer overlaid by the border define a plurality of pockets, each pocket has a width along the glide sheet perimeter, the pocket widths are defined by stitches located between adjacent pockets along the glide sheet perimeter, the stitches extend through at least the border and the portion of the bottom material layer overlaid by the border, and each pocket has an opening facing away from the glide sheet peripheral edge of its respective border, the opening receivable of caregiver fingers into the pocket, whereby each pocket defines a handle for use by the caregiver(s) for moving the glide sheet during patient repositioning.

3. The positioning device of claim 2, wherein the border is formed along two laterally opposite peripheral edges of the glide sheet.

4. The positioning device of claim 3, wherein the border is formed along at least one peripheral edge of the glide sheet that extends between the two laterally opposite peripheral edges of the glide sheet.

5. The positioning device of claim 2, wherein the stitches that are located between two adjacent pockets along the glide sheet perimeter, extend linearly in an arc extending between opposite ends, and the arc opposite ends are proximate a single peripheral edge or a pair of adjacent peripheral edges of the glide sheet.

6. The positioning device of claim 2, wherein between two adjacent pockets along a peripheral edge of the glide sheet, the glide sheet is provided with a buttonhole extending through the glide sheet proximate the respective peripheral edge of the glide sheet.

7. A positioning system comprising the positioning device of claim 6 and a removeable, elongate handle assembly, the handle assembly comprising an elongate strap portion defined by a fabric ribbon having a lateral first width approximating the length of the glide sheet buttonhole, the ribbon folded over itself longitudinally to define a handle assembly first end and an opposing handle assembly second end;
wherein the elongate strap portion is affixed to itself at loci between the handle assembly first end and the handle assembly second end to define a plurality of loops, the plurality of loops distributed along the length of the handle assembly with a first loop of the plurality of loops located at the handle assembly first end and a second loop of the plurality of loops located at the handle assembly second end;
wherein the handle assembly second end is selectively receivable through both the glide sheet buttonhole and the first loop, with the second loop and at least a portion of a third loop of the plurality of loops disposed between the handle assembly second end and the first loop and are receivable of at least the fingers of a caregiver hand, whereby the second and third loops define a plurality of handles located at different distances from the glide sheet for use by the caregiver(s) for moving the glide sheet during patient repositioning, whereby SPH practices by caregivers of various heights and reaches are promoted; and
wherein the handle assembly is removable subsequent to use by the caregiver(s), from the glide sheet buttonhole, whereby patient extremity and handle assembly entanglement is avoided while the patient is unattended.

8. The positioning system of claim 7, wherein the handle assembly comprises an abutment portion defined by a fabric ribbon that is laterally centered and affixed to the elongate strap portion, the abutment portion having a generally rigid first end proximate the first loop and a longitudinally opposite, generally rigid second end proximate the next adjacent one of the plurality of loops;
wherein the abutment portion has a lateral second width that is substantially greater than the first width and the length of the buttonhole, and movement of the elongate strap portion of the handle assembly through the button hole is limited by abutting contact between the glide sheet and laterally outward edge segments of the abutment portion second end, whereby the first loop remains positioned outside the perimeter of the glide sheet.

9. The positioning system of claim 7, comprising a replaceable, moisture-absorbent pad for optional use with the glide sheet, the pad adherently positionable on the top side surface of the glide sheet during use.

10. The positioning system of claim 9, wherein the pad has longitudinally opposite ends and laterally opposite edges, and comprises a pair of parallel, longitudinally-extending, adhesive strips that extend substantially the entire longitudinal length of the pad;
wherein each of the adhesive strips is located in proximity to a respective one of the laterally opposite edges of the pad, and the pad retained to the top side surface of the glide sheet by the adhesive strips along the entire length of the pad, whereby bunching of the longitudinally centermost portion of the pad and other undesirable displacement of the pad relative to the glide sheet is prevented.

11. A positioning system comprising the positioning device of claim 1 and a replaceable, moisture-absorbent pad for optional use with the glide sheet, the pad adherently positionable on the top side surface of the glide sheet during use.

12. The positioning system of claim 11, wherein the pad has longitudinally opposite ends and laterally opposite edges, and comprises a pair of parallel, longitudinally-extending, adhesive strips that extend substantially the entire longitudinal length of the pad;
wherein each of the adhesive strips is located in proximity to a respective one of the laterally opposite edges of the pad, and the pad retained to the top side surface of the glide sheet by the adhesive strips along the entire length of the pad, whereby bunching of the longitudinally centermost portion of the pad and other undesirable displacement of the pad relative to the glide sheet is prevented.

13. A positioning device for facilitating the turning or repositioning of a bedridden patient by one or more caregivers, the positioning device comprising:
a glide sheet having a top side surface superposeable by the patient during use and an opposite, bottom side surface adapted to superpose a support surface during use, the top side surface and the bottom side surface each bounded by peripheral edges of the glide sheet;
wherein the glide sheet includes a plurality of handles located inwardly of the glide sheet peripheral edges; and
wherein the plurality of handles is located between the top side surface and the bottom side surface of the glide sheet, whereby patient extremity and handle entanglement is avoided and SPH practices are promoted.

14. The positioning device of claim 13, wherein the top side surface is defined by a top material layer and the bottom side surface is defined by a first piece of bottom material, the bottom material has a coefficient of friction that is less than the coefficient of friction of the top material layer, and the top material layer superposes and is affixed to the first piece of bottom material;
wherein the bottom side surface includes a plurality of elongate, hemmed second pieces of bottom material that are disposed in overlying relationship with the first piece of bottom material, and the second pieces of bottom material form borders along at least two glide sheet peripheral edges, each border having an inward edge and an outward edge, each border outward edge substantially aligned with a respective peripheral edge of the glide sheet;
wherein the plurality of handles along each peripheral side is defined by a continuous ribbon of fabric, the ribbon positioned between and spaced from the respective border inward edge and outward edge, and disposed between the border and overlaid portion of the first piece of bottom material, each second piece of bottom material attached along its border inward edge to the first piece of bottom layer material;
wherein, along the perimeter of the glide sheet, each border and the portion of the first piece of bottom material overlaid by the border defines a plurality of pockets, each pocket has a width along the glide sheet perimeter, the pocket widths are defined by stitches located between adjacent pockets along the respective glide sheet peripheral edge, the stitches extend through at least the border, the ribbon and the portion of the bottom material layer overlaid by the border; and
wherein each pocket has an opening in the respective glide sheet peripheral edge, the opening receivable of caregiver fingers into the pocket and containing a portion of the ribbon, whereby each pocket contains a handle for use by the caregiver(s) for moving the glide sheet during patient repositioning.

15. The positioning device of claim 14, wherein a border and a ribbon are disposed along two laterally opposite peripheral edges of the glide sheet.

16. The positioning device of claim 15, wherein a border and a ribbon are disposed along at least one peripheral edge of the glide sheet that extends between the two laterally opposite peripheral edges of the glide sheet.

17. The positioning device of claim 14, wherein the stitches that are located between two adjacent pockets along the glide sheet perimeter, are bartack stitches that extend linearly in directions inwardly from a respective peripheral edge of the glide sheet, and extend through the thicknesses of the border, the ribbon of fabric, the first piece of bottom material and the top material layer.

18. A positioning system comprising the positioning device of claim 14 and a removeable, elongate handle assembly, the handle assembly comprising an elongate strap portion defined by a fabric ribbon, the ribbon folded over itself longitudinally to define a handle assembly first end and an opposing handle assembly second end;
wherein the elongate strap portion is affixed to itself at loci between the handle assembly first end and the handle assembly second end to define a plurality of loops, the plurality of loops distributed along the length of the handle assembly with a first loop of the plurality of loops located at the handle assembly first end and a second loop of the plurality of loops located at the handle assembly second end;
wherein the handle assembly second end is selectively receivable into a pocket of the glide sheet through a pocket opening, wrappable about the handle portion therein and then receivable through the first loop, with the second loop and at least a portion of a third loop of the plurality of loops disposed between the handle assembly second end and the first loop and are receivable of at least the fingers of a caregiver hand, whereby the second and third loops define a plurality of handles located at different distances from the glide sheet for use by the caregiver(s) for moving the glide sheet during patient repositioning, whereby SPH practices by caregivers of various heights and reaches are promoted; and
wherein the handle assembly is removable subsequent to use by the caregiver(s), from the glide sheet pocket, whereby patient extremity and handle assembly entanglement is avoided while the patient is unattended.

19. The positioning system of claim 18, comprising a replaceable, moisture-absorbent pad for optional use with the glide sheet, the pad adherently positionable on the top side surface of the glide sheet during use.

20. The positioning system of claim 19, wherein the pad has longitudinally opposite ends and laterally opposite edges, and comprises a pair of parallel, longitudinally-extending, adhesive strips that extend substantially the entire longitudinal length of the pad;
wherein each of the adhesive strips is located in proximity to a respective one of the laterally opposite edges of the pad, and the pad retained to the top side surface of the glide sheet by the adhesive strips along the entire length of the pad, whereby bunching of the longitudinally centermost portion of the pad and other undesirable displacement of the pad relative to the glide sheet is prevented.

21. A positioning system comprising the positioning device of claim 13 and a replaceable, moisture-absorbent pad for optional use with the glide sheet, the pad adherently positionable on the top side surface of the glide sheet during use.

22. The positioning system of claim 21, wherein the pad has longitudinally opposite ends and laterally opposite edges, and comprises a pair of parallel, longitudinally-extending, adhesive strips that extend substantially the entire longitudinal length of the pad;
wherein each of the adhesive strips is located in proximity to a respective one of the laterally opposite edges of the pad, and the pad retained to the top side surface of the glide sheet by the adhesive strips along the entire length of the pad, whereby bunching of the longitudinally centermost portion of the pad and other undesirable displacement of the pad relative to the glide sheet is prevented.
